(19) United States
(12) Patent Application Publication
(10) Pub. No.: US 2006/0202922 A1
(43) Pub. Date: Sep. 14, 2006

(54) Method for optimizing a purification procedure

(76) Inventors: Christopher P. Hanna, Park Ridge, IL (US); Douglas T. Gjerde, Saratoga, CA (US)

Correspondence Address: PHYNEXUS, INC., 3670 CHARTER PARK DRIVE, SAN JOSE, CA, 95136, US

(21) Appl. No.: 11/373,535

(22) Filed: Mar. 9, 2006

Related U.S. Application Data
(60) Provisional application No. 60/660,595, filed on Mar. 10, 2005.

(51) Int. Cl. G09G 3/30

(52) U.S. Cl. 345/76

(57) ABSTRACT

This invention relates to a method of optimizing a process for extracting an analyte from a liquid sample. A plurality of samples can be processed simultaneously while varying several factors independently to determine extraction efficiency under a wide variety of conditions.

### CROSS REFERENCE TO RELATED APPLICATIONS

This application claims priority to and benefit of U.S. Provisional Patent Application No. 60/660,595 filed Mar. 10, 2005; U.S. patent application Ser. No. 10/620,155, filed Jul. 14, 2003; U.S. patent application Ser. No. 10/434,713, filed May 8, 2003; U.S. patent application Ser. No. 10/793,449, file Mar. 4, 2004; U.S. patent application Ser. No. 10/754,775, filed Jan. 8, 2004; U.S. patent application Ser. No. 10/733,534, filed Dec. 10, 2003; and U.S. patent application Ser. No. 10/921,010 filed Aug. 17, 2004, the disclosures of which are incorporated herein by reference in their entirety for all purposes.

### FIELD OF THE INVENTION

This invention relates to a method of optimizing a process for extracting an analyte from a liquid sample, wherein the process is characterized by a plurality of factors that can be independently varied and which affect the efficiency of the extraction.

### BRIEF DESCRIPTION OF THE FIGURES

FIG. 1A depicts the number of capture cycles used in each column corresponding to each well of a 96-well microplate used in Example 1. FIG. 1B depicts a 96-well plate with the concentration of imidazole used in each column for the wash step of Example 1.

FIG. 2 depicts a 96-well microplate with the concentration of imidazole used in each column for the elution in Example 1.

FIG. 3A depicts the number of capture cycles used in each column corresponding to each well of a 96-well microplate used in Example 2. FIG. 3B depicts a 96-well plate with the concentration of imidazole used in each column for the wash step of Example 2.

FIG. 4 depicts the concentration for citrate in the elution buffer used in each of 96 columns in Example 2.

FIG. 5 shows the number of capture cycles used for each of 96 columns in Example 3.

### DESCRIPTION OF SPECIFIC EMBODIMENTS OF THE INVENTION

Definitions

In describing and claiming the present invention, the following terminology will be used in accordance with the definitions set out below.

The term “bed volume” as used herein is defined as the volume of a bed of extraction media in an extraction column. Depending on how densely the bed is packed, the volume of the extraction media in the column bed is typically about one third to two thirds of the total bed volume; well packed beds have less space between the beads and hence generally have lower interstital volumes.

The term “interstitial volume” of the bed refers to the volume of the bed of extraction media that is accessible to solvent, e.g., aqueous sample solutions, wash solutions and desorption solvents. For example, in the case where the extraction media is a chromatography bead (e.g., agarose or sepharose), the interstitial volume of the bed constitutes the solvent accessible volume between the beads, as well as any solvent accessible internal regions of the bead, e.g., solvent accessible pores. The interstitial volume of the bed represents the minimum volume of liquid required to saturate the column bed.

The term “dead volume” as used herein with respect to a column is defined as the interstitial volume of the extraction bed, tubes, membrane or frits, and passageways in a column. Some preferred embodiments of the invention involve the use of low dead volume columns, as described in more detail in U.S. patent application Ser. No. 10/620,155.

The term “elution volume” as used herein is defined as the volume of desorption or elution liquid into which the analytes are desorbed and collected. The terms “desorption solvent,” “elution liquid” and the like are used interchangeably herein.

The term “enrichment factor” as used herein is defined as the ratio of the sample volume divided by the elution volume, assuming that there is no contribution of liquid coming from the dead volume. To the extent that the dead volume either dilutes the analytes or prevents complete adsorption, the enrichment factor is reduced.

The terms “extraction column” and “extraction tip” as used herein are defined as a column device used in combination with a pump, the column device containing a bed of solid phase extraction material, i.e., extraction media.

The term “frit” as used herein are defined as porous material for holding the extraction media in place in a column. An extraction media chamber is typically defined by a top and bottom frit positioned in an extraction column. In preferred embodiments of the invention the frit is a thin, low pore volume filter, e.g., a membrane screen.

The term “lower column body” as used herein is defined as the column bed and bottom membrane screen of a column.

The term “membrane screen” as used herein is defined as a woven or non-woven fabric or screen for holding the column packing in place in the column bed, the membranes having a low dead volume. The membranes are of sufficient strength to withstand packing and use of the column bed and of sufficient porosity to allow passage of liquids through the column bed. The membrane is thin enough so that it can be sealed around the perimeter or circumference of the membrane screen so that the liquids flow through the screen.

The term “sample volume”, as used herein is defined as the volume of the liquid of the original sample solution from which the analytes are separated or purified.

The term “upper column body”, as used herein is defined as the chamber and top membrane screen of a column.

The term “biomolecule” as used herein refers to biomolecule derived from a biological system. The term includes biological macromolecules, such as a proteins, peptides, and nucleic acids.

The term “protein chip” is defined as a small plate or surface upon which an array of separated, discrete protein samples are to be deposited or have been deposited. These protein samples are typically small and are sometimes referred to as “dots.” In general, a chip bearing an array of discrete proteins is designed to be contacted with a sample having one or more biomolecules which may or may not have the capability of binding to the surface of one or more of the dots, and the occurrence or absence of such binding on each dot is subsequently determined. A reference that describes the general types and functions of protein chips is Gavin MacBeath, Nature Genetics Supplement, 32:526 (2002).

The present invention provides, inter alia, a method of optimizing a process for extracting an analyte from a liquid sample, wherein the process is characterized by a plurality of factors that can be independently varied and which affect the efficiency of the extraction. The invention can be applied to a variety of extraction and sample purification processes, exemplified by processes involving the use of extraction devices having a sing entrance for the input and output of liquids, e.g., sample solution, wash and elution buffers. Examples of such extraction devices include pipette tip columns and extraction capillaries, as described in Published U.S. Patent Application Nos. US2004/0072375, US2005/0019951, US2004/100887, US2004/0241721, and US2004/0126890.

The term “independently varied across the plurality of extraction processes” refers to the concept of varying the factors in a variety of factorial combinations, thereby achieving a variety of conditions that provide the data used to optimize a purification protocol. Examples of independent variation across a plurality of extraction processes” are provided in the Examples section of this specification.

The term “assessing the efficiency” of an extraction process refers to an analysis of the process which assesses the efficiency of the extraction in achieving a desired outcome. In the Examples, efficiency is determined in terms of the total quantity of extracted analyte. There can be a variety of other measures of efficiency, depending upon the interest of the experimenter, which can likewise be assessed. Examples would include fold purification of the analyte, the removal of a particular contaminant, or contaminants in general, the functional integrity of the analyte, and the like.

In some embodiments of the invention, at least two factors in the purification procedure are varied independently in a factorial or fractional factorial design. In certain embodiments Design of Experiment is used to design a factorial or fractional factorial design. Design of Experiment is a structured, organized method that is used to determine the relationship between the different factors affecting a process and the output of that process. This method was first developed in the 1920s and 1930, by Sir Ronald A. Fisher, the renowned mathematician and geneticist.

Design of Experiment involves designing a set of experiments, in which all relevant factors are varied systematically. When the results of these experiments are analyzed, they help to identify optimal conditions, the factors that most influence the results, and those that do not, as well as details such as the existence of interactions and synergies between factors. Factorial and experimental design, including the principles of Design of Experiment are known by those of skill in the art, and are described in a number of publications, including the following, all of which are incorporated herein by reference in their entirety: Design and Analysis of Experiments, Fifth Edition, by Douglas C. Montgomery (2001, John Wiley and Sons); DOE Simplified: Practical Tools for Effective Experimentation (Quality Management), by Mark Atkinson and Patrick Whitcomb (2000, Productivity Press, Inc.); Design of Experiments for Engineers and Scientists by Jiju Anthony (2003, Butterworth-Heinemann).

In many extraction processes, additional steps, such as wash steps, neutralization steps, step gradient elutions and the like are employed.

The processes of the invention are typically implemented by an automated, preferably robotic system, such as the MEA Purification System, commercially available from Phynexus, Inc. (San Jose, Calif.). The system and instructions for its use in automated purification processes are described in greater detail in the PHYTIP MEA Purification System Manual, included herewith as Appendix A.

The factors to be considered, varied and optimized are diverse and abundant, and include, but are not limited to: variation in the analyte itself, variation in the extraction chemistry, variation in the composition of any solution being passed through the extraction device, variation in the flow rate of a solution through the extraction devices, variation in the number of passages of a solution through the extraction devices, variation in the volume of any solution passed through the extraction devices, variation in the temperature of a solution passed through the extraction device, and variation in the temperature of the extraction device. Other variables within the optimization of the columns or capillaries can also be studied with this factorial method. For example, the optimization of covalent immobilization conditions for the columns and capillaries; the optimization of capillary synthesis conditions; the optimization of step-wise elution conditions for piecemeal “disassembly” of protein complexes; the optimization of step-wise loading conditions for piecemeal “assembly” of protein complexes. In addition, the factorial approach can be used analytically for creating step-wise “gradients” across a microplate, for example, loading the same sample onto each tip and eluting with a gradually stronger eluent in each well and then detecting the differences in response for each well (thus creating a reconstituted “chromatogram”), analytical “disassembly” or “assembly” of protein complexes; resolution of differentially post-translationally-modified proteins.

The invention is particularly suited to processes wherein liquid solutions, such as the analyte-containing sample and elution liquids, washes, and the like, are provided in microplate wells. The use of microplates, including by not limited to the ubiquitous 96-well plate, 384-well plates and 1536-well plates are particularly suited for use in high-throughput processes facilitated by the instant invention.

The use of Design of Experiment requires that consistent and reproducible results can be obtained when multiple samples are processed simultaneously. To obtain consistent results, it is necessary for the methods to be reproducible between columns (inter-column reproducibility) and within a column (intra-column reproducibility). The results obtained in Example 1 show inter-column reproducibility, which in turn indicates intra-column reproducibility.

The analyte can be, but is not limited to, biomolecules, particularly proteins, peptides, polynucleotides, polysaccharides, lipids and the like.

The number of factors to be varied can be two or more. For example, one can vary the flow rates during a capture step, the number of cycles the solution is passed through the extraction device, as well as the pH and composition of a wash and/or elution buffer. The factors can be varied to take two or more values, e.g., the concentration of a constituent of a buffer can be varied from 0, 10, 25, 50, 100, 200, to 500 mM.

In some instances, two or more of the factors are correlated or partially correlated, meaning that variation of one factor has some influence on the affect of varying a correlated factor. In such cases the use of Design of Experiment principles can be particularly useful in obtaining the maximum information from an experiment. In other cases, factors might be totally independent, such that variation of one factor does not impact the effect of varying another factor.

Extraction Columns

In accordance with the present invention there may be employed conventional chemistry, biological and analytical techniques within the skill of the art. Such techniques are explained fully in the literature. See, e.g. Chromatography, 5^{th} edition, PART A: FUNDAMENTALS AND TECHNIQUES, editor: E. Heftmann, Elsevier Science Publishing Company, New York (1992); ADVANCED CHROMATOGRAPHIC AND ELECTROMIGRATION METHODS IN BIOSCIENCES, editor: Z. Deyl, Elsevier Science BV, Amsterdam, The Netherlands, (1998); CHROMATOGRAPHY TODAY, Colin F. Poole and Salwa K. Poole, and Elsevier Science Publishing Company, New York, (1991).

In some embodiments of the subject invention the packed bed of extraction media is contained in a column, e.g., a low dead volume column. Non-limiting examples of suitable columns, particularly low dead volume columns, are presented herein. It is to be understood that the subject invention is not to be construed as limited to the use of extraction beds in low dead volume columns, or in columns in general. For example, the invention is equally applicable to use with a packed bed of extraction media as a component of a multi-well plate.

Column Body

The column body is a tube having two open ends connected by an open channel, sometimes referred to as a through passageway. The tube can be in any shape, including but not limited to cylindrical or frustoconical, and of any dimensions consistent with the function of the column as described herein. In some preferred embodiments of the invention the column body takes the form of a pipette tip, a syringe, a luer adapter or similar tubular bodies. In embodiments where the column body is a pipette tip, the end of the tip wherein the bed of extraction media is placed can take any of a number of geometries, e.g., it can be tapered or cylindrical. In some case a cylindrical channel of relatively constant radius can be preferable to a tapered tip, for a variety of reason, e.g., solution flows through the bed at a uniform rate, rather than varying as a function of a variable channel diameter.

In some embodiments, one of the open ends of the column, sometimes referred to herein as the open upper end of the column, is adapted for attachment to a pump, either directly or indirectly. In some embodiments of the invention the upper open end is operatively attached to a pump, whereby the pump can be used for aspirating (i.e., drawing) a fluid into the extraction column through the open lower end of the column, and optionally for discharging (i.e., expelling) fluid out through the open lower end of the column. Thus, it is a feature certain embodiments of the present invention that fluid enters and exits the extraction column through the same open end of the column, typically the open lower end. This is in contradistinction with the operation of some extraction columns, where fluid enters the column through one open end and exits through the other end after traveling through an extraction media, i.e., similar to conventional column chromatography. The fluid can be a liquid, such as a sample solution, wash solution or desorption solvent. The fluid can also be a gas, e.g., air used to blow liquid out of the extraction column.

In other embodiments of the present invention, fluid enters the column through one end and exits through the other. In some embodiments, the invention provides extraction methods that involve a hybrid approach; that is, one or more fluids enter the column through one end and exit through the other, and one more fluids enter and exit the column through the same open end of the column, e.g., the lower end. Thus, for example, in some methods the sample solution and/or wash solution are introduced through the top of the column and exit through the bottom end, while the desorption solution enters and exits through the bottom opening of the column. Aspiration and discharge of solution through the same end of the column can be particularly advantageous in procedures designed to minimize sample loss, particularly when small volumes of liquid are used. A good example would be a procedure that employs a very small volume of desorption solvent, e.g., a procedure involving a high enrichment factor.

The column body can be can be composed of any material that is sufficiently non-porous that it can retain fluid and that is compatible with the solutions, media, pumps and analytes used. A material should be employed that does not substantially react with substances it will contact during use of the extraction column, e.g., the sample solutions, the analyte of interest, the extraction media and desorption solvent. A wide range of suitable materials are available and known to one of skill in the art, and the choice is one of design. Various plastics make ideal column body materials, but other materials such as glass, ceramics or metals could be used in some embodiments of the invention. Some examples of preferred materials include polysulfone, polypropylene, polyethylene, polyethyleneterephthalate, polyethersulfone, polytetrafluoroethylene, cellulose acetate, cellulose acetate butyrate, acrylonitrile PVC copolymer, polystyrene, polystyrene/acrylonitrile copolymer, polyvinylidene fluoride, glass, metal, silica, and combinations of the above listed materials.

Some specific examples of suitable column bodies are provided in the Examples.

Extraction Media

The extraction media used in the column is preferably a form of water-insoluble particle (e.g., a porous or non-porous bead) that has an affinity for an analyte of interest. Typically the analyte of interest is a protein, peptide or nucleic acid. The extraction processes can be affinity, size exclusion, reverse phase, normal phase, ion exchange, hydrophobic interaction chromatography, or hydrophilic interaction chromatography agents. In general, the term “extraction media” is used in a broad sense to encompass any media capable of effecting separation, either partial or complete, of an analyte from another. Thus, the terms “separation column” and “extraction column” can be used interchangeably. The term “analyte” can refer to any compound of interest, e.g., to be analyzed or simply removed from a solution.

The bed volume of the extraction media used in the extraction columns of the invention is typically small, typically in the range of 0.1-1000 μL, preferably in the range of 0.1-100 μL, e.g., in a range having a lower limit of 0.1, 0.5, 1, 1.5, 2, 2.5, 3, 5 or 10 μL; and an upper limit of 5, 10, 15, 20, 30, 40 50, 60, 70, 80, 90, 100, 150, 200, 300, 400 or 500 μL. The low bed volume contributes to a low interstitial volume of the bed, reducing the dead volume of the column, thereby facilitating the recovery of analyte in a small volume of desorption solvent.

The low bed volumes employed in certain embodiments allow for the use of relatively small amounts of extraction media, e.g., soft, gel-type beads. For example, some embodiments of the invention employ a bed of extraction media having a dry weight of less than 1 gram (e.g., in the range of 0.001-1 g, 0.005-1 g, 0.01-1 g or 0.02-1 g), less than 100 mg (e.g., in the range of 0.1-100 mg, 0.5-100 mg, 1-100 mg 2-100 mg, or 10-100 mg), less than 10 mg (e.g., in the range of 0.1-10 mg, 0.5-10 mg, 1-10 mg or 2-10 mg), less than 2 mg (e.g., in the range of 0.1-2 mg, 0.5-2 mg or 1-2 mg), or less than 1 mg (e.g., in the range of 0.1-1 mg or 0.5-1 mg).

Many of the extraction media types suitable for use in the invention are selected from a variety of classes of chromatography media. It has been found that many of these chromatography media types and the associated chemistries are suited for use as solid phase extraction media in the devices and methods of this invention.

Thus, examples of suitable extraction media include resin beads used for extraction and/or chromatography. Preferred resins include gel resins, pellicular resins, and macroporous resins.

The term “gel resin” refers to a resin comprising low-crosslinked bead materials that can swell in a solvent, e.g., upon hydration. Crosslinking refers to the physical linking of the polymer chains that form the beads. The physical linking is normally accomplished through a crosslinking monomer that contains bi-polymerizing functionality so that during the polymerization process, the molecule can be incorporated into two different polymer chains. The degree of crosslinking for a particular material can range from 0.1 to 30%, with 0.5 to 10% normally used. 1 to 5% crosslinking is most common. A lower degree of crosslinking renders the bead more permeable to solvent, thus making the functional sites within the bead more accessible to analyte. However, a low crosslinked bead can be deformed easily, and should only be used if the flow of eluent through the bed is slow enough or gentle enough to prevent closing the interstitial spaces between the beads, which could then lead to catastrophic collapse of the bed. Higher crosslinked materials swell less and may prevent access of the analytes and desorption materials to the interior functional groups within the bead. Generally, it is desirable to use as low a level of crosslinking as possible, so long is it is sufficient to withstand collapse of the bed. This means that in conventional gel-packed columns, slow flow rates may have to be used. In the present invention the back pressure is very low, and high liquid flow rates can be used without collapsing the bed. Surprisingly, using these high solvent velocities does not appear to reduce the capacity or usefulness of the bead materials. Common gel resins include agarose, sepharose, polystyrene, polyacrylate, cellulose and other substrates. Gel resins can be non-porous or micro-porous beads.

The low back pressure associated with certain columns of the invention results in some cases in the columns exhibiting characteristics not normally associated with conventional packed columns. For example, in some cases it has been observed that below a certain threshold pressure solvent does not flow through the column. This threshold pressure can be thought of as a “bubble point.” In conventional columns, the flow rate through the column generally increases from zero as a smooth function of the pressure at which the solvent is being pushed through the column. With many of the columns of the invention, a progressively increasing pressure will not result in any flow through the column until the threshold pressure is achieved. Once the threshold pressure is reached, the flow will start at a rate significantly greater than zero, i.e., there is no smooth increase in flow rate with pressure, but instead a sudden jump from zero to a relatively fast flow rate. Once the threshold pressure has been exceeded flow commences, the flow rate typically increases relatively smoothly with increasing pressure, as would be the case with conventional columns.

The term “pellicular resins” refers to materials in which the functional groups are on the surface of the bead or in a thin layer on the surface of the bead. The interior of the bead is solid, usually highly crosslinked, and usually inaccessible to the solvent and analytes. Pellicular resins generally have lower capacities than gel and macroporous resins.

The term “macroporous resin” refers to highly crosslinked resins having high surface area due to a physical porous structure that formed during the polymerization process. Generally an inert material (such as a solid or a liquid that does not solvate the polymer that is formed) is polymerized with the bead and then later washed out, leaving a porous structure. Crosslinking of macroporous materials range from 5% to 90% with perhaps a 25 to 55% crosslinking the most common materials. Macroporous resins behave similar to pellicular resins except that in effect much more surface area is available for interaction of analyte with resin functional groups.

Examples of resins beads include polystyrene/divinylbenzene copolymers, poly methylmethacrylate, protein G beads (e.g., for IgG protein purification), MEP Hypercel™ beads (e.g., for IgG protein purification), affinity phase beads (e.g., for protein purification), ion exchange phase beads (e.g., for protein purification), hydrophobic interaction beads (e.g., for protein purification), reverse phase beads (e.g., for nucleic acid or protein purification), and beads having an affinity for molecules analyzed by label-free detection. Silica beads are also suitable.

Soft gel resin beads, such as agarose and sepharose based beads, are found to work surprisingly well in columns and methods of this invention. In conventional chromatography fast flow rates can result in bead compression, which results in increased back pressure and adversely impacts the ability to use these gels with faster flow rates. In the present invention relatively small bed volumes are used, and it appears that this allows for the use of high flow rates with a minimal amount of bead compression and the problem attendant with such compression.

The average particle diameters of beads of the invention are typically in the range of about 1 μm to several millimeters, e.g., diameters in ranges having lower limits of 1 μm, 5 μm, 10 μm, 20 μm, 30 μm, 40 μm, 50 μm, 60 μm, 70 μm, 80 μm, 90 μm, 100 μm, 150 μm, 200 μm, 300 μm, or 500 μm, and upper limits of 10 μm, 20 μm, 30 μm, 40 μm, 50 μm, 60 μm, 70 μm, 80 μm, 90 μm, 100 μm, 150 μm, 200 μm, 300 μm, 500 μm, 750 μm, 1 mm, 2 mm, or 3 mm.

The bead size that may be used depends somewhat on the bed volume and the cross sectional area of the column. A lower bed volume column will tolerate a smaller bead size without generating the high backpressures that could burst a thin membrane frit. For example a bed volume of 0.1 to 1 μL bed, can tolerate 5 to 10 μm particles. Larger beds (up to about 50 μL) normally have beads sizes of 30-150 μm or higher. The upper range of particle size is dependant on the diameter of the column bed. The bead diameter size should not be more than 50% of the bed diameter, and preferably less than 10% of the bed diameter.

The extraction chemistry employed in the present invention can take any of a wide variety of forms. For example, the extraction media can be selected from, or based on, any of the extraction chemistries used in solid-phase extraction and/or chromatography, e.g., reverse-phase, normal phase, hydrophobic interaction, hydrophilic interaction, ion-exchange, thiophilic separation, hydrophobic charge induction or affinity binding. Because the invention is particularly suited to the purification and/or concentration of biomolecules, extraction surfaces capable of adsorbing such molecules are particularly relevant. See, e.g., SEPARATION AND SCIENCE TECHNOLOGY Vol. 2.:HANDBOOK OF BIOSEPARATIONS, edited by Satinder Ahuja, Academic Press (2000).

Affinity extractions use a technique in which a bio-specific adsorbent is prepared by coupling a specific ligand (such as an enzyme, antigen, or hormone) for the analyte, (e.g., macromolecule) of interest to a solid support. This immobilized ligand will interact selectively with molecules that can bind to it. Molecules that will not bind elute un-retained. The interaction is selective and reversible. The references listed below show examples of the types of affinity groups that can be employed in the practice of this invention are hereby incorporated by reference herein in their entireties. Antibody Purification Handbook, Amersham Biosciences, Edition AB, 18-1037-46 (2002); Protein Purification Handbook, Amersham Biosciences, Edition AC, 18-1132-29 (2001); Affinity Chromatography Principles and Methods, Amersham Pharmacia Biotech, Edition AC, 18-1022-29 (2001); The Recombinant Protein Handbook, Amersham Pharmacia Biotech, Edition AB, 18-1142-75 (2002); and Protein Purification: Principles, High Resolution Methods, and Applications, Jan-Christen Janson (Editor), Lars G. Ryden (Editor), Wiley, John & Sons, Incorporated (1989).

Examples of suitable affinity binding agents are summarized in Table I, wherein the affinity agents are from one or more of the following interaction categories:
1. Chelating metal—ligand interaction
2. Protein—Protein interaction
3. Organic molecule or moiety—Protein interaction
4. Sugar—Protein interaction
5. Nucleic acid—Protein interaction

6. Nucleic acid—nucleic acid interaction

TABLE I

| Examples of Affinity | | |
|---|---|---|
| molecule or moiety fixed at | | Interaction |
| surface | Captured biomolecule | Category |
| Ni-NTA | His-tagged protein | 1 |
| Ni-NTA | His-tagged protein within a | 1, 2 |
| | multi-protein complex | |
| Fe-IDA | Phosphopeptides, | 1 |
| | phosphoproteins | |
| Fe-IDA | Phosphopeptides or | 1, 2 |
| | phosphoproteins within a | |
| | multi-protein complex | |
| Antibody or other Proteins | Protein antigen | 2 |
| Antibody or other Proteins | Small molecule-tagged | 3 |
| | protein | |
| Antibody or other Proteins | Small molecule-tagged | 2, 3 |
| | protein within a multi- | |
| | protein complex | |
| Antibody or other Proteins | Protein antigen within a | 2 |
| | multi-protein complex | |
| Antibody or other Proteins | Epitope-tagged protein | 2 |
| Antibody or other Proteins | Epitope-tagged protein | 2 |
| | within a multi-protein | |
| | complex | |
| Protein A, Protein G or | Antibody | 2 |
| Protein L | | |
| Protein A, Protein G or | Antibody | 2 |
| Protein L | | |
| ATP or ATP analogs; 5′- | Kinases, phosphatases | 3 |
| AMP | (proteins that requires ATP | |
| | for proper function) | |
| ATP or ATP analogs; 5′- | Kinase, phosphatases | 2, 3 |
| AMP | within multi-protein | |
| | complexes | |
| Cibacron 3G | Albumin | 3 |
| Heparin | DNA-binding protein | 4 |
| Heparin | DNA-binding proteins | 2, 4 |
| | within a multi-protein | |
| | complex | |
| Lectin | Glycopeptide or | 4 |
| | glycoprotein | |
| Lectin | Glycopeptide or | 2, 4 |
| | glycoprotein within a | |
| | multi-protein complex | |
| ssDNA or dsDNA | DNA-binding protein | 5 |
| ssDNA or dsDNA | DNA-binding protein | 2, 5 |
| | within a multi-protein | |
| | complex | |
| ssDNA | Complementary ssDNA | 6 |
| ssDNA | Complementary RNA | 6 |
| Streptavidin/Avidin | Biotinylated peptides | 3 |
| | (ICAT) | |
| Streptavidin/Avidin | Biotinylated engineered tag | 3 |
| | fused to a protein (see | |
| | avidity.com) | |
| Streptavidin/Avidin | Biotinylated protein | 3 |
| Streptavidin/Avidin | Biotinylated protein within | 2, 3 |
| | a multi-protein complex | |
| Streptavidin/Avidin | Biotinylated engineered tag | 2, 3 |
| | fused to a protein within a | |
| | multi-protein complex | |
| Streptavidin/Avidin | Biotinylated nucleic acid | 3 |
| Streptavidin/Avidin | Biotinylated nucleic acid | 2, 3 |
| | bound to a protein or multi- | |
| | protein complex | |
| Streptavidin/Avidin | Biotinylated nucleic acid | 3, 6 |
| | bound to a complementary | |
| | nucleic acid | |

In one aspect of the invention an extraction media is used that contains a surface functionality that has an affinity for a protein fusion tag used for the purification of recombinant proteins. A wide variety of fusion tags and corresponding affinity groups are available and can be used in the practice of the invention.

U.S. patent application Ser. No. 10/620,155 describes in detail the use of specific affinity binding reagents in solid-phase extraction. Examples of specific affinity binding agents include proteins having an affinity for antibodies, Fc regions and/or Fab regions such as Protein G, Protein A, Protein A/G, and Protein L; chelated metals such as metal-NTA chelate (e.g., Nickel NTA, Copper NTA, Iron NTA, Cobalt NTA, Zinc NTA), metal-IDA chelate (e.g., Nickel IDA, Copper IDA, Iron IDA, Cobalt IDA) and metal-CMA (carboxymethylated aspartate) chelate (e.g., Nickel CMA, Copper CMA, Iron CMA, Cobalt CMA, Zinc CMA); glutathione surfaces-nucleotides, oligonucleotides, polynucleotides and their analogs (e.g., ATP); lectin surface-heparin surface-avidin or streptavidin surface, a peptide or peptide analog (e.g., that binds to a protease or other enzyme that acts upon polypeptides).

In some embodiments of the invention, the affinity binding reagent is one that recognizes one or more of the many affinity groups used as affinity tags in recombinant fusion proteins. Examples of such tags include poly-histidine tags (e.g., the 6X-His tag), which can be extracted using a chelated metal such as Ni—NTA-peptide sequences (such as the FLAG epitope) that are recognized by an immobilized antibody; biotin, which can be extracted using immobilized avidin or streptavidin; “calmodulin binding peptide” (or, CBP), recognized by calmodulin charged with calcium-glutathione S-transferase protein (GST), recognized by immobilized glutathione; maltose binding protein (MBP), recognized by amylose; the cellulose-binding domain tag, recognized by immobilized cellulose; a peptide with specific affinity for S-protein (derived from ribonuclease A); and the peptide sequence tag CCxxCC (where xx is any amino acid, such as RE), which binds to the affinity binding agent bis-arsenical fluorescein (FIAsH dye).

Antibodies can be extracted using, for example, proteins such as protein A, protein G, protein L, hybrids of these, or by other antibodies (e.g., an anti-IgE for purifying IgE).

Chelated metals are not only useful for purifying poly-his tagged proteins, but also other non-tagged proteins that have an intrinsic affinity for the chelated metal, e.g., phosphopeptides and phosphoproteins.

Antibodies can also be useful for purifying non-tagged proteins to which they have an affinity, e.g., by using antibodies with affinity for a specific phosphorylation site or phosphorylated amino acids.

In other embodiments of the invention extraction surfaces are employed that are generally less specific than the affinity binding agents discussed above. These extraction chemistries are still often quite useful. Examples include ion exchange, reversed phase, normal phase, hydrophobic interaction and hydrophilic interaction extraction or chromatography surfaces. In general, these extraction chemistries, methods of their use, appropriate solvents, etc. are well known in the art, and in particular are described in more detail in U.S. patent application Ser. Nos. 10/434,713 and 10/620,155, and references cited therein, e.g., Chromatography, 5^{th} edition, PART A: FUNDAMENTALS AND TECHNIQUES, editor: E. Heftmann, Elsevier Science Publishing Company, New York, pp A25 (1992); ADVANCED CHROMATOGRAPHIC AND ELECTROMIGRATION METHODS IN BIOSCIENCES, editor: Z. Deyl, Elsevier Science BV, Amsterdam, The Netherlands, pp 528 (1998); CHROMATOGRAPHY TODAY, Colin F. Poole and Salwa K. Poole, and Elsevier Science Publishing Company, New York, pp 3 94 (1991); and ORGANIC SYNTHESIS ON SOLID PHASE, F. Dorwald Wiley VCH Verlag Gmbh, Weinheim 2002.

Frits

In some embodiments of the invention one or more frits is used to contain the bed of extraction in, for example, a column. Frits can take a variety of forms, and can be constructed from a variety of materials, e.g., glass, ceramic, metal, fiber. Some embodiments of the invention employ frits having a low pore volume, which contribute to reducing dead volume. The frits of the invention are porous, since it is necessary for fluid to be able to pass through the frit. The frit should have sufficient structural strength so that frit integrity can contain the extraction media in the column. It is desirable that the frit have little or no affinity for chemicals with which it will come into contact during the extraction process, particularly the analyte of interest. In many embodiments of the invention the analyte of interest is a biomolecule, particularly a biological macromolecule. Thus in many embodiments of the invention it desirable to use a frit that has a minimal tendency to bind or otherwise interact with biological macromolecules, particularly proteins, peptides and nucleic acids.

Frits of various pores sizes and pore densities may be used provided the free flow of liquid is possible and the beads are held in place within the extraction media bed.

In one embodiment, one frit (e.g., a lower, or bottom, frit) is bonded to and extends across the open channel of the column body. Preferably, the bottom frit is attached at or near the open lower end of the column, e.g., bonded to and extend across the open lower end. Normally, a bed of separation media, such as an extraction media, is positioned inside the open channel and in contact with the bottom frit. However, in some cases a column with a bottom frit and no bed of media can be useful for certain techniques encompassed by this invention. For example, a pipette tip with a frit at the open lower end can be used to take up a liquid sample without taking up solid or particulate material in the sample. The solid or particulate material might be gel fragments, beads, etc. In this context, the bottom frit is essentially acting as a filter, and a membrane screen can serve as a particularly appropriate bottom frit.

In certain embodiments, an optional top frit may be employed. For example, in some embodiments a second frit is bonded to and extends across the open channel between the bottom frit and the open upper end of the column body. In this embodiment, the top frit, bottom frit and column body (i.e., the inner surface of the channel) define an extraction media chamber wherein a bed of extraction media is positioned. The frits should be securely attached to the column body and extend across the opening and /or open end so as to completely occlude the channel, thereby substantially confining the bed of extraction media inside the extraction media chamber. In preferred embodiments of the invention the bed of extraction media occupies at least 80% of the volume of the extraction media chamber, more preferably 90%, 95%, 99%, or substantially 100% of the volume. In some preferred embodiments the invention the space between the extraction media bed and the upper and lower frits is negligible, i.e., the frits are in substantial contact with upper and lower surfaces of the extraction media bed, holding a well-packed bed of extraction media securely in place.

In some preferred embodiments of the invention the bottom frit is located at the open lower end of the column body. This configuration is shown in the figures and exemplified in the Examples, but is not required, i.e., in some embodiments the bottom frit is located at some distance up the column body from the open lower end. However, in view of the advantage the come with minimizing dead volume in the column, it is desirable that the lower frit and extraction media chamber be located at or near the lower end. In some cases this can mean that the bottom frit is attached to the face of the open lower end however, in other cases there can be some portion of the lower end extending beyond the bottom frit. For the purposes of this invention, so long as the length as this extension is such that it does not substantially introduce dead volume into the extraction column or otherwise adversely impact the function of the column, the bottom frit is considered to be located at the lower end of the column body. In some embodiments of the invention the volume defined by the bottom frit, channel surface, and the face of the open lower end (i.e., the channel volume below the bottom frit) is less than the volume of the extraction media chamber, or less than 10% of the volume of the extraction media chamber, or less than 1% of the volume of the extraction media chamber.

In some embodiments of the invention, the extraction media chamber is positioned near one end of the column, which for purposes of explanation will be described as the bottom end of the column. The area of the column body channel above the extraction media chamber can be can be quite large in relation to the size of the extraction media chamber. For example, in some embodiments the volume of the extraction chamber is equal to less than 50%, less than 20, less than 10%, less than 5%, less than 2%, less than 1% or less than 0.5% of the total internal volume of the column body. In operation, solvent can flow through the open lower end of the column, through the bed of extraction media and out of the extraction media chamber into the section of the channel above the chamber. For example, when the column body is a pipette tip, the open upper end can be fitted to a pipettor and a solution drawn through the extraction media and into the upper part of the channel.

The frits used in the invention are preferably characterized by having a low pore volume. Some preferred embodiments invention employ frits having pore volumes of less than 1 microliter (e.g., in the range of 0.015-1 microliter, 0.03-1 microliter, 0.1 - 1 microliter or 0.5-1 microliter), preferably less than 0.5 microliter (e.g., in the range of 0.015-0.5 microliter, 0.03-0.5 microliter or 0.1-0.5 microliter), less than 0.1 microliter (e.g., in the range of 0.015-0.1 microliter or 0.03-0.1 microliter) or less than 0.03 microliters (e.g., in the range of 0.015-0.03 microliter).

Frits of the invention preferably have pore openings or mesh openings of a size in the range of about 5-100 μm, more preferably 10-100 μm, and still more preferably 15-50 μm, e.g., about 43 μm. The performance of the column is typically enhanced by the use of frits having pore or mesh openings sufficiently large so as to minimize the resistance to flow. The use of membrane screens as described herein typically provide this low resistance to flow and hence better flow rates, reduced back pressure and minimal distortion of the bed of extraction media. The pre or mesh openings of course should not be so large that they are unable to adequately contain the extraction media in the chamber.

Some frits used in the practice of the invention are characterized by having a low pore volume relative to the interstitial volume of the bed of extraction media contained by the frit. Thus, in preferred embodiments of the invention the frit pore volume is equal to 10% or less of the interstitial volume of the bed of extraction media (e.g., in the range 0.1-10%, 0.25- 10%,1 -10% or 5-10% of the interstitial volume), more preferably 5% or less of the interstitial volume of the bed of extraction media (e.g., in the range 0.1-5%, 0.25-5% or 1-5% of the interstitial volume), and still more preferably 1% or less of the interstitial volume of the bed of extraction media (e.g., in the range 0.01-1%, 0.05-1% or 0.1-1% ofthe interstitial volume).

The pore density will allow flow of the liquid through the membrane and is preferably 10% and higher to increase the flow rate that is possible and to reduce the time needed to process the sample.

Some embodiments of the invention employ a thin frit, preferably less than 350 lm in thickness (e.g., in the range of 20-350 μm, 40-350 μm, or 50-350 μm), more preferably less than 200 μm in thickness (e.g., in the range of 20-200 μm, 40-200 μm, or 50-200 μm), more preferably less than 100 μm in thickness (e.g., in the range of 20-100 μm, 40-100 μm, or 50-100 μm), and most preferably less than 75 μm in thickness (e.g., in the range of 20-75 μm, 40-75 μm, or 50-75 μm).

Some preferred embodiments of the invention employ a membrane screen as the frit. The membrane screen should be strong enough to not only contain the extraction media in the column bed, but also to avoid becoming detached or punctured during the actual packing of the media into the column bed. Membranes can be fragile, and in some embodiments must be contained in a framework to maintain their integrity during use. However, it is desirable to use a membrane of sufficient strength such that it can be used without reliance on such a framework. The membrane screen should also be flexible so that it can conform to the column bed. This flexibility is advantageous in the packing process as it allows the membrane screen to conform to the bed of extraction media, resulting in a reduction in dead volume.

The membrane can be a woven or non-woven mesh of fibers that may be a mesh weave, a random orientated mat of fibers i.e. a “”polymer paper,” a spun bonded mesh, an etched or “pore drilled” paper or membrane such as nuclear track etched membrane or an electrolytic mesh (see, e.g., U.S. Pat. No. 5,556,598). The membrane may be, e.g., polymer, glass, or metal provided the membrane is low dead volume, allows movement of the various sample and processing liquids through the column bed, may be attached to the column body, is strong enough to withstand the bed packing process, is strong enough to hold the column bed of beads, and does not interfere with the extraction process i.e. does not adsorb or denature the sample molecules.

The frit can be attached to the column body by any means which results in a stable attachment. For example, the screen can be bonded to the column body through welding or gluing. Gluing can be done with any suitable glue, e.g., silicone, cyanoacrylate glue, epoxy glue, and the like. The glue or weld joint must have the strength required to withstand the process of packing the bed of extraction media and to contain the extraction media with the chamber. For glue joints, a glue should be selected employed that does not adsorb or denature the sample molecules.

For example, glue can be used to attach a membrane to the tip of a pipet tip-based extraction column, i.e., a column wherein the column body is a pipet tip. A suitable glue is applied to the end of the tip. In some cases, a rod may be inserted into the tip to prevent the glue from spreading beyond the face of the body. After the glue is applied, the tip is brought into contact with the membrane frit, thereby attaching the membrane to the tip. After attachment, the tip and membrane may be brought down against a hard flat surface and rubbed in a circular motion to ensure complete attachment of the membrane to the column body. After drying, the excess membrane may be trimmed from the column with a razor blade.

Alternatively, the column body can be welded to the membrane by melting the body into the membrane, or melting the membrane into the body, or both. In one method, a membrane is chosen such that its melting temperature is higher than the melting temperature of the body. The membrane is placed on a surface, and the body is brought down to the membrane and heated, whereby the face of the body will melt and weld the membrane to the body. The body may be heated by any of a variety of means, e.g., with a hot flat surface, hot air or ultrasonically. Immediately after welding, the weld may be cooled with air or other gas to improve the likelihood that the weld does not break apart.

Alternatively, a frit can be attached by means of an annular pip, as described in U.S. Pat. No. 5,833,927. This mode of attachment is particularly suited to embodiment where the frit is a membrane screen.

The frits of the invention, e.g., a membrane screen, can be made from any material that has the required physical properties as described herein. Examples of suitable materials include nylon, polyester, polyamide, polycarbonate, cellulose, polyethylene, nitrocellulose, cellulose acetate, polyvinylidine difluoride, polytetrafluoroethylene (PTFE), polypropylene, polysulfone, metal and glass. A specific example of a membrane screen is the 43 μm pore size Spectra/Mesh® polyester mesh material which is available from Spectrum Labs (Ranch Dominguez, Calif., PN 145837). Pore size characteristics of membrane filters can be determined, for example, by use of method #F316-30, published by ASTM International, entitled “Standard Test Methods for Pore Size Characteristics of Membrane Filters by Bubble Point and Mean Flow Pore Test.”

The polarity of the membrane screen can be important. A hydrophilic screen will promote contact with the bed and promote the air - liquid interface setting up a surface tension. A hydrophobic screen would not promote this surface tension and therefore the threshold pressures to flow would be different. A hydrophilic screen is preferred in certain embodiments of the invention.

However, depending upon the context in which the device is used, it can be preferable to use either a hydrophilic membrane, such as polyester, or a hydrophobic membrane, such as nylon, or a combination of hydrophobic and hydrophilic membranes, e.g., a hydrophilic membrane on top and hydrophilic membrane on the bottom. For example, the use of a hydrophobic membrane as the top and/or bottom frit can improve flow characteristics of the column, particularly in automated implementations of the invention, such as by means of a robotic liquid handling system. Without intending to be bound by any particularly theory of operation, it seems likely that use of a hydrophobic membrane in conjunction with aqueous solutions will generate reduced surface tension, resulting in reduced bubble point and thus reduced back pressure. Examples of hydrophobic and hydrophilic membranes would include, for example, membranes comprising nylon and polyester, respectively.

In certain embodiments of the invention, a wad of fibrous material is included in the device, which extends across the open channel between the bottom frit and the open upper end of the column body, wherein the wad of fibrous material, bottom frit and open channel define a media chamber, wherein the bed of extraction media is positioned within the media chamber. In some embodiments, the wad of fibrous material is used in lieu of an upper frit, i.e., there is a single lower frit and a wad of fibrous material defining the media chamber. In other embodiments, both a top frit and a wad of fibrous material are used. For example, the fibrous material can be positioned within the open channel and in contact with the top frit, e.g., the wad of fibrous material can be positioned between the top frit and the open upper end, or between the bottom and top frits, i.e., within the media chamber.

The wad of fibrous material can have any of a variety of dimensions or sizes. For example, the volume of the wad in certain devices is between 1% and 1000% of the volume of the media chamber, preferably between 5% and 500%, or 10% and 100%, of the volume of the media chamber. In some embodiments, the wad of fibrous material comprises polyester or polyethylene fiber.

Without intending to be bound by any particular theory, it is believed that the wad of fibrous material can facilitate movement of solution through the bed of extraction material by acting as a wicking agent. This particularly the case where a gas such as air is present in or adjacent to the bed of extraction media, which can increase the back pressure of moving liquid through the column, particularly where the gas is a bubble in contact with a membrane screen. A membrane screen, particularly one that is hydrophilic, can result in a relatively high bubble point that causes an increase in back pressure; the use of a wicking agent alleviates this problem.

Before describing the present invention in detail, it is to be understood that this invention is not limited to specific embodiments described herein. It is also to be understood that the terminology used herein for the purpose of describing particular embodiments is not intended to be limiting. As used in this specification and the appended claims, the singular forms “a”, “an” and “the” include plural referents unless the context clearly dictates otherwise.

Unless defined otherwise, all technical and scientific terms used herein have the same meaning as commonly understood by one of ordinary skill in the art to which the invention pertains. Although any methods and materials similar or equivalent to those described herein can be used in the practice or testing of the present invention, specific examples of appropriate materials and methods are described herein.

Before describing several exemplary embodiments of the invention, it is to be understood that the invention is not limited to the details of construction or process steps set forth in the following description. The invention is capable of other embodiments and of being practiced or being carried out in various ways.

All publications and patent applications mentioned in this specification are herein incorporated by reference to the same extent as if each individual publication or patent application was specifically and individually indicated to be incorporated by reference.

Having now generally described the invention, the same will be more readily understood through reference to the following examples, which are provided by way of illustration, and are not intended to be limiting of the present invention, unless so specified.

### EXAMPLES

The following preparations and examples are given to enable those skilled in the art to more clearly understand and practice the present invention. They should not be construed as limiting the scope of the invention, but merely as being illustrative and representative thereof.

### Example 1

### Optimization of Capture, Purification and Elution of Immobilized-Metal Affinity Chromatography (IMAC) Pipette Tip Columns with Imidazole Elution

In this example, optimum conditions were studied for the purification of ubiquitin from an E. coli lysate. 20 μg of His₆-Ubiquitin (BostonBiochem cat. #U-530) was spiked into 200 μL of an E. coli lysate, with the pH adjusted to 7.4 by the addition of a volume of 5× buffer (25 mM imidazole, 50 mM NaH₂PO₄, 1.5 M NaCl, pH 7.4) equal to ¼ the total volume of ubiquitin-spiked lysate. The purification method was optimized with regard to three independent variables: (1) the number of capture cycles, (2) the concentration of imidazole in the wash, and (3) the concentration of the imidazole in the elution buffer.

The extraction process was performed using an MEA automated purification system (PhyNexus, Inc.), which is described in more detail in the MEA Operation Manual (attached hereto as Appendix A), and PHYTIP 200+ pipette tip-based IMAC extraction columns (PhyNexus, Inc.). Pipette tip columns are described in more detail in Published U.S. Patent Applications Nos. US2004/0072375 and US2005/0019951, incorporated by reference herein in their entirety. The MEA instrument was programmed to perform capture, purification and elution steps as described in the MEA Operation Manual (attached hereto as Appendix A).

Capture

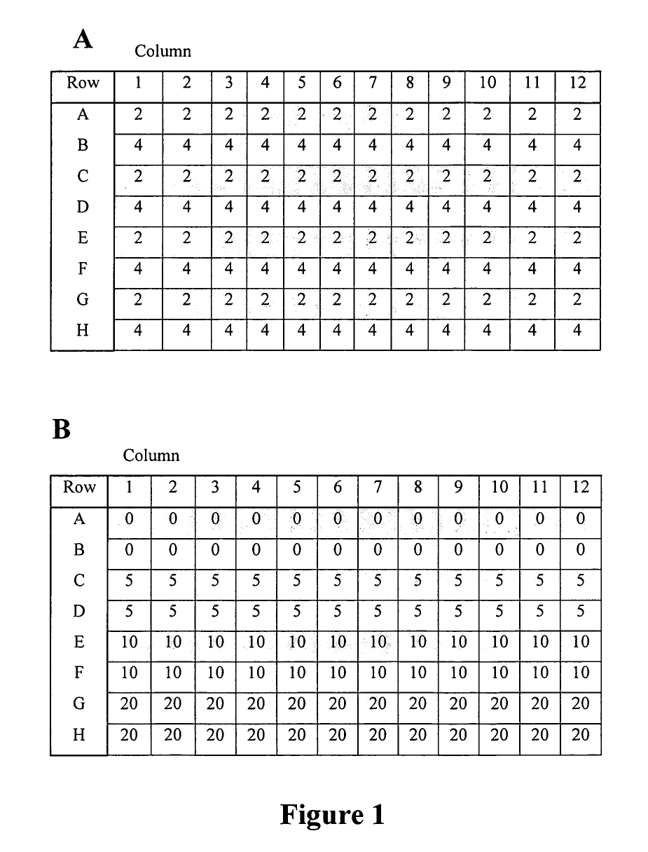

A standard 96-well microplate was arrayed with 96 aliquots of the pH-adjusted, ubiquitin-spiked E. coli lysates described above. The 96 well plate is depicted schematically in FIG. 1A, with row and column identifiers to define the location of each of the 96 wells (these same designations are used throughout the figures). A box of 96 PHYTIP IMAC columns was placed in Position 1 of the MEA instrument deck. The MEA instrument was programmed to perform Capture protocols, the protocols specifying 2 capture cycles for Rows A, C, E & G and 4 capture cycles for Rows B, D, F & H (as depicted in the schematic), both at flow rates of 250 μL/min.

Purification Step 1

The wash process for purification was optimized by varying the concentration of imidazole in the wash buffer. A 96-well microplate was placed into Position 3 on the instrument deck and arrayed with 200 μL aliquots of wash buffers varying in the concentration of imidazole. Rows A&B had 0 mM imidazole in the wash buffer (10 mM NaH₂PO₄, 140 mM NaCl, pH 7.4), rows C&D had 5 mM (5 mM imidazole, 2.5 mM NaH₂PO₄, 7.5 mM NaCl, pH 7.4), E&F had 10 mM (10 mM imidazole, 5 mM NaH₂PO₄, 15 mM NaCl, pH 7.4), and G&H had 20 mM (20 mM imidazole, 10 mM NaH₂PO₄, 30 mM NaCl, pH 7.4), as depicted in FIG. 1B. The MEA instrument was programmed to run 2 cycles of wash buffer through each tip column, at flow rates of 500 μL/min.

Purification Step 2

A second microplate arrayed with the identical set of wash buffers as in Purification Step 1 (see FIG. 1B) was positioned in Position 4 of the instrument deck, and the MEA instrument was programmed to repeat the same protocol as used in Purificaiton Step 1.

Elution

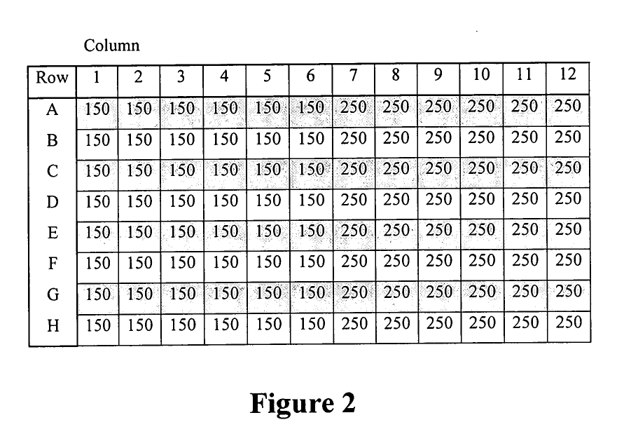

The elution step was optimized by varying the concentration imidazole in the elution buffer. A 96-well microplate was placed into Position 5 on the MEA instrument deck and arrayed with 20 μL aliquots of PBS elution buffers varying in the concentration of imidazole. The wells in columns 1-6 were loaded with a 150 mM imidazole PBS buffer (6 mM NaH₂PO₄, 84 mM NaCl, pH 7.4) and columns 7-12 were loaded with a 250 mM imidazole PBS buffer (10 mM NaH₂PO₄, 140 mM NaCl, pH 7.4) as shown in FIG. 2. The MEA instrument was programmed to run 2 cycles of elution buffer through each tip column (at flow rates of 500 uL/min), and then to expel the eluant into a well in a microplate positioned at Position 7 on the MEA instrument deck. Each eluant was expelled into the same well position as that in which the original sample was arrayed in the sample tray.

The MEA instrument was then instructed to perform the programmed purification protocol for the 96 samples, and the amount of total purified ubiquitin purified from each extraction was quantified by HPLC. In total, 16 distinct conditions were tested. This is an example of a factorial design of experiment which allows evaluation of two or more conditions or variables simultaneously. The advantages of factorial designs over one-factor-at-a-time experiments is that they are more efficient and they allow interactions to be detected. This experiment permitted a statistically significant number of comparisons of capture conditions, wash conditions and elution conditions in a single experiment that was run in less than 2 hours.

In this experiment, there were 2 capture cycle conditions (2 or 4 capture cycles), 4 wash buffer conditions (1, 5, 10 or 20 mM imidazole), and 2 elution buffer conditions (2×4×2=16). A total of 16 different conditions were tested with six replicates of each condition. The results are shown in Table A below. Within Table A, each number (#) represents a specific set of elution and capture conditions (e.g., #1 reports protein recovery for 2 capture cycles and 150 mM imidazole in the elution buffer), and each column in the table represents the 6 replicates at each wash buffer imidazole concentration (0, 5, 10 or 20 mM). Recovery is reported in terms of μg of ubiquitin, as determined by quantitative HPLC analysis. For example, recovery for 2 capture cycles and 150 mM imidazole elution buffer, with no imidazole in wash, was 4.75, 4.34, 4.09, 4.07, 3.80, and 3.44 μg over 6 replicates, for an average recovery of 4.08 μg and a standard deviation of 0.45 μg (10.95%). #5 summarizes the results, reporting the average recovery (in μg) for each condition.

The use of Design of Experiment requires that consistent and reproducible results can be obtained when multiple samples are processed simultaneously. The results in Table A clearly demonstrate that the values are consistent between columns (inter-column reproducibility). Further, in order to get consistent results across 96 columns, it is necessary for each column to perform consistently throughout the extraction process (intra-column reproducibility). For example, it is necessary for the solution containing an analyte to flow through (and thus bind) the extraction medium reproducibly during each draw/expel cycle. The results obtained in Table A show inter-column reproducibility, which is not possible without intra-column reproducibility.

TABLE A

| | | | |
|---|---|---|---|
| 0 | 5 | 10 | 20 |

#1 150 2 cycles

| | | | | |
|---|---|---|---|---|
| | 4.75 | 4.53 | 4.73 | 4.72 |
| | 4.34 | 3.77 | 4.37 | 4.49 |
| | 4.09 | 4.60 | 4.57 | 4.17 |
| | 4.07 | 4.56 | 4.25 | 4.42 |
| | 3.80 | 4.10 | 4.44 | 4.65 |
| | 3.44 | 4.29 | 4.61 | 4.06 |
| Average | 4.08 | 4.31 | 4.49 | 4.42 |
| Std Dev | 0.45 | 0.32 | 0.17 | 0.26 |
| % | 10.98 | 7.52 | 3.83 | 5.95 |

#2 150 4 cycles

| | | | | |
|---|---|---|---|---|
| | 5.32 | 5.53 | 6.43 | 5.45 |
| | 5.05 | 4.84 | 5.52 | 4.98 |
| | 4.86 | 4.48 | 5.58 | 5.03 |
| | 4.90 | 5.08 | 5.95 | 5.07 |
| | 4.23 | 4.96 | 5.35 | 4.79 |
| | 4.65 | 4.59 | 4.96 | 4.43 |
| Average | 4.84 | 4.91 | 5.63 | 4.96 |
| Std Dev | 0.37 | 0.38 | 0.51 | 0.34 |
| % | 7.64 | 7.66 | 9.00 | 6.81 |

#3 250 2 cycles

| | | | | |
|---|---|---|---|---|
| | 8.39 | 8.61 | 8.45 | 7.98 |
| | 7.82 | 8.01 | 7.09 | 7.64 |
| | 7.89 | 8.67 | 8.02 | 7.56 |
| | 7.93 | 8.47 | 7.71 | 7.42 |
| | 7.62 | 8.04 | 8.24 | 7.50 |
| | 7.08 | 7.00 | 7.43 | 7.01 |
| Average | 7.79 | 8.13 | 7.79 | 7.52 |
| Std Dev | 0.43 | 0.63 | 0.55 | 0.32 |
| % | 5.48 | 7.69 | 7.04 | 4.21 |

#4 250 4 cycles

| | | | | |
|---|---|---|---|---|
| | 9.98 | 10.08 | 9.72 | 8.62 |
| | 9.04 | 9.80 | 9.72 | 8.42 |
| | 9.83 | 9.62 | 9.36 | 8.46 |
| | 9.38 | 9.29 | 9.61 | 8.99 |
| | 9.30 | 9.54 | 9.81 | 9.00 |
| | 8.25 | 8.26 | 8.60 | 8.13 |
| Average | 9.30 | 9.43 | 9.47 | 8.60 |
| Std Dev | 0.62 | 0.63 | 0.45 | 0.34 |
| % | 6.64 | 6.71 | 4.80 | 3.97 |

#5

| | | | | |
|---|---|---|---|---|
| 2 Cycles | 4.08 | 4.31 | 4.49 | 4.42 |
| 150 mM | | | | |
| 4 Cycles | 4.84 | 4.91 | 5.63 | 4.96 |
| 150 mM | | | | |
| 2 Cycles | 7.79 | 8.13 | 7.79 | 7.52 |
| 250 mM | | | | |
| 4 Cycles | 9.30 | 9.43 | 9.47 | 8.60 |
| 250 mM | | | | |

### Example 2

### Optimization of Purification and Elution of IMAC Pipette Tip Columns with Low pH Citrate Elution

In this example, optimum conditions are studied for the purification of ubiquitin from an E. coli lysate. 20 μg of ubiquitin is spiked into 200 μL of an E. coli lysate, with the pH adjusted to 7.4 by the addition of a volume of 5× buffer (25 mM imidazole, 50 mM NaH₂PO₄, 1.5 M NaCl, pH 7.4) equal to ¼ the total volume of ubiquitin-spiked lysate. The purification method is optimized with regard to two independent variables: (1) the concentration of imidazole in the wash, and (2) the concentration and pH of a citrate elution buffer.

The extraction process is performed using an MEA automated purification system (PhyNexus, Inc.), which is described in more detail in the MEA Operation Manual (attached hereto as Appendix A), and PHYTIP 200+ pipette tip-based IMAC extraction columns (PhyNexus, Inc.). The MEA instrument is programmed to perform the capture, purification and elution steps as described in the MEA Operation Manual (attached hereto as Appendix A).

Capture

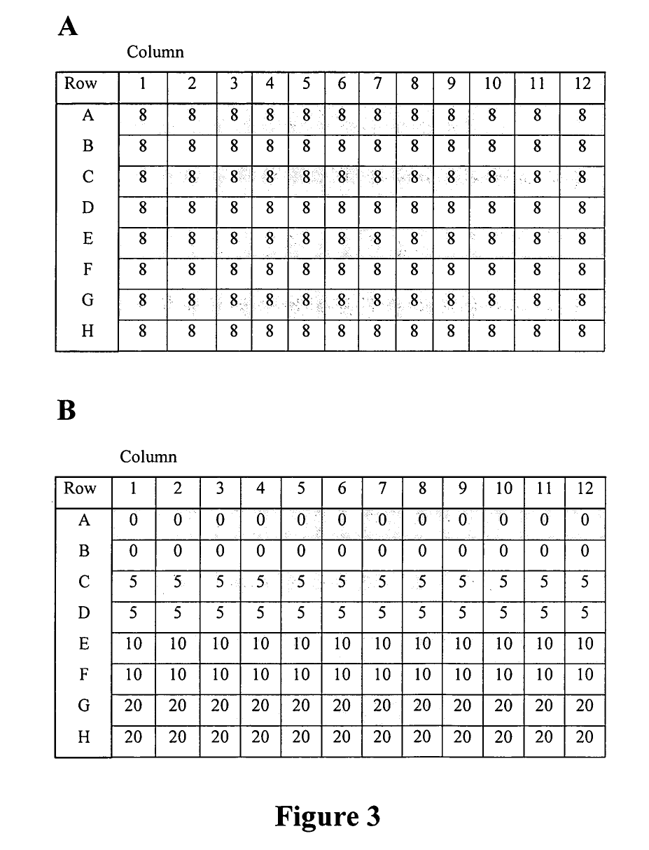

A standard 96-well microplate is arrayed with 96 aliquots of the, pH-adjusted, ubiquitin-spiked E. coli lysates described above. The 96-well plate is depicted schematically in FIG. 3A, with row and column identifiers to define the location of each of the 96 wells (these same designations are used throughout the figures). A box of 96 PHYTIP IMAC columns is placed in Position 1 of the MEA instrument deck. The MEA instrument is programmed to perform Capture protocols at flow rates of 250 μL/min. In this example it is desired to capture as much protein as possible but not have the number of capture cycles as a variable. Capture protocol for Rows A-H is 8 cycles.

Purification Step 1

The wash process for purification is optimized by varying the concentration of imidazole in the wash buffer. A 96-well microplate is placed into Position 3 on the instrument deck and arrayed with 200 μL aliquots of wash buffers varying in the concentration of imidazole. Rows A&B have 0 mM imidazole in the wash buffer (10 mM NaH₂PO₄, 140 mM NaCl, pH 7.4), rows C&D have 5 mM (5 mM imidazole, 2.5 mM NaH₂PO₄, 7.5 mM NaCl, pH 7.4), E&F have 10 mM (10 mM imidazole, 5 mM NaH₂PO₄, 15 mM NaCl, pH 7.4), and G&H have 20 mM (20 mM imidazole, 10 mM NaH₂PO₄, 30 mM NaCl, pH 7.4), as depicted in FIG. 3B. The MEA instrument is programmed to run 2 cycles of wash buffer through each tip column, at flow rates of 500 μL/min.

Purification Step 2

A second microplate arrayed with water in each well (to remove any residual imidazole) is placed in Position 4 of the instrument deck, and the MEA instrument is programmed to repeat the same protocol as used in Purification Step 1.

Elution

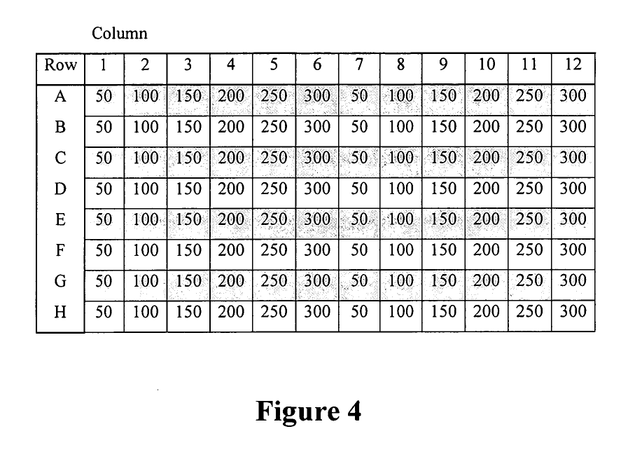

The final elution step is optimized by varying the pH and concentration of sodium citrate in a citrate elution buffer. A 96-well microplate is placed into Position 5 on the instrument deck and arrayed with 20 μL aliquots of citrate elution buffers varying in pH and sodium citrate concentration. The pH is adjusted with NaCl. The concentration of citrate is 50, 100, 150, 200, 250, and 300 mM, as shown below in columns 1-6 and 7-12 of FIG. 4. Columns 1-6 are adjusted to pH 3.0 citrate and Columns 7-12 are adjusted to pH 4.5. The MEA instrument is programmed to run 2 cycles of elution buffer through each tip column (at flow rates of 500 uL/min), and then to expel the eluant into a well in a microplate positioned at Position 7 on the MEA instrument deck. Each eluant is expelled into the same well position as that in which the original sample was arrayed in the sample tray.

The eluting power of citrate steadily increases with increasing concentration. 50 mM citrate and 100 mM citrate are poor eluting buffers although 100 mM citrate will give some useable protein. Greater amounts of protein are achieved with 150-300 mM citrate with 300 mM citrate giving the greatest amount of protein corresponding to approximately 70% yield. Both pH 3.0 and 4.5 citrate solutions give acceptable recoveries (excluding 50 and 100 mM citrate) with pH 4.5 citrate solutions giving approximately 15-20% higher yields than pH 3.0 citrate.

The MEA instrument is then instructed to perform the programmed purification protocol for the 96 samples, and the amount of total purified ubiquitin purified from each extraction is quantified by HPLC. In total, 48 distinct conditions are tested. This is an example of a factorial design experiment. There are 4 wash buffer conditions (1, 5, 10 or 20 mM imidazole), 6 citrate concentration conditions (50, 100, 150, 200, 250, and 300 mM), and 2 elution buffer pH conditions (pH 3.0 and 4.5) (4×6×2=48). 2 replicates of each condition are run.

### Example 3

### Optimization of Capture Cycles and Flow Rate and Elution Cycles and Volumes for Protein A Pipette Tip Columns

In this example, optimum conditions are studied for the purification of IgG from an E. coli lysate. 20 μg of IgG is spiked into 200 μL of an E. coli lysate, with the pH adjusted to 7.4 by the addition of a volume of 5× buffer (25 mM imidazole, 50 mM NaH₂PO₄, 1.5 M NaCl, pH 7.4) equal to ¼ the total volume of IgG-spiked lysate. The purification method is optimized with regard to four independent variables factors: (1) capture flow rate, (2) number of capture cycles, (3) elution buffer pH, and (4) the number of elution cycles.

The extraction process is performed using an MEA automated purification system (PhyNexus, Inc.), which is described in more detail in the MEA Operation Manual (attached hereto as Appendix A), and PHYTIP 200+ pipette tip-based Protein A extraction columns (PhyNexus, Inc.). The MEA instrument is programmed to perform the capture, purification and elution steps as described in the MEA Operation Manual (attached hereto as Appendix A).

Capture

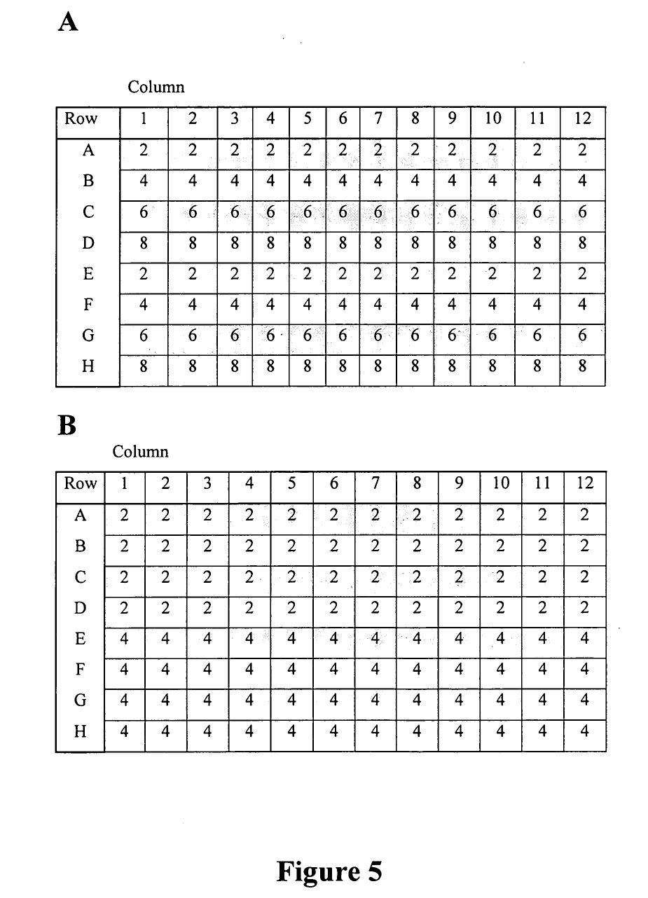

In this example, the flow rate is adjusted to 100 μL/min and 200 μL/min with 2, 4, 6 and 8 capture cycles. The number of capture cycles is shown in FIG. 5A. Rows A-D have a capture flow rate of 100 μL/min and Rows E-H have a capture flow rate of 200 μL/min.

Purification Step 1

The wash process for purification is the same of all 96 wells. 200 μL of pH 7.4 PBS wash is run with 2 cycles each at flow rates of 500 μL/min.

Purification Step 2

In this wash, 100 mM saline is used to remove any residual pH 7.4 PBS from the first wash. 200 μL of the saline wash is run with 2 cycles each at a flow rate of 500 μL/min.

Elution

The final elution step is performed with an elution buffer (111 mM NaH₂PO₄, 140 mM NaCl in 14.8 mM H₃PO₄), adjusted to either pH 2.5 or pH 3.0. The buffer is pH 2.5 in Columns 1-6 and pH 3.0 in Columns 7-12. Rows A-D are performed with 2 cycles of 20 μL elution volume and Rows E-H are performed with 4 cycles of 20 μL elution volume as shown in FIG. 5B. The flow rate is 500 μL/min.

Increasing the number of capture cycles increases the recovery of the protein in all cases to as high as 50% higher recoveries. There is improvement in all cases of 4 cycles vs. 2 cycles; 6 cycles vs. 4 cycles, etc. The pH 2.5 phosphoric acid eluting solvent increases recovery 5-30% over the pH 3.0 eluting solvent. The number of eluting cycles has very little effect on the recovery of the protein.

### Example 4

### Optimization of Purification and Elution of IMAC Extraction Capillaries with Low pH Citrate Elution

The optimization experiment of Example 2 is repeated, substituting an IMAC extraction capillary (200 μm i.d.×1 m length, as described in Published U.S. Patent Application No. US2004/100887) for the pipette tip columns. The flow rates are adjusted to 100 μL/min for the capture and purification steps and 25 μL/min for the elution step.

### Example 5

### Optimization of Capture Cycles and Flow Rate and Elution Cycles and Volumes for Protein A Extraction Capillaries

The optimization experiment of Example 3 is repeated, substituting a Protein G extraction capillary (200 μm i.d.×1 m length, as described in Published U.S. Patent Application No. US2004/100887) for the pipette tip columns. The flow rates are adjusted to 100 μL/min for the capture and purification steps and 25 μL/min for the elution step.

### Example 6

### Parallel Extraction Using Open-Tube Capillary Columns

The ME-100 hardware for controlling liquid flow through the open-tube capillary columns is a ten-channel syringe pump programmed through an RS232 serial port to aspirate and dispense fluids through the 1 meter long, coiled open-tube capillary columns. To achieve sample loading, 1 mL disposable syringes are loaded into the appropriate syringe cassette. The open-tube capillary columns are pressed onto the ends of the syringes via epoxied female Luer fittings, and the column openings are submerged into 500 mL of sample to be processed. The sample is drawn into the disposable syringe through the open-tube capillary column (internal volume ˜30 mL) at a rate of 150 mL/min, followed by expelling of the sample through the open-tube capillary at the same flow rate. This draw/expel cycle is performed four times, for a total of eight exposures of the sample to the column surface.

Once the sample is loaded, the open-tube capillary column openings are submerged into 500 mL of wash buffer (typically comprised of PBS+10 mM imidazole, pH 7.4; in the case of membrane proteins the buffer is 10 mM HEPES, 10 mM NaCl, 1% OBG+10 mM imidazole, pH 8). This buffer is drawn into and expelled from the same 1 mL disposable syringe at a rate of 150 mL/min, for one draw/expel cycle. Once completed, the columns are removed from the syringes and attached to a nitrogen source. This nitrogen source is allowed to flow through the open-tube capillary column at 50 psi for 60 seconds, thus purging the bulk liquid from the capillary prior to the elution step.

To achieve elution from the open tube columns, 50 mL glass syringes are loaded into the appropriate syringe cassette. The loaded, washed and purged capillaries were pressed onto the ends of the syringes and the column openings are submerged into 2-15 mL of eluent (typically comprised of PBS+250 mM imidazole, pH 7.4). The syringe pump is programmed to withdraw the entire elution volume through the capillary at 30 mL/min, which allows the entire elution volume to be maintained as a single liquid segment. This elution segment is drawn to the top of the open-tube capillary column and is NOT allowed to enter the 50 mL glass syringe (in contrast to the loading and washing steps). Through pump programming, the elution segment is then pushed back to the bottom of the column at 30 mL/min and is not allowed to be expelled through the column opening. This back-and-forth eluent cycling is performed a total of four times (for a total of eight exposures of the eluent segment to the open-tube capillary column surface). Upon completion of the elution cycling, the liquid segment is expelled from the column and collected for further analyses.

There are a number of conditions that can be varied to optimize the parallel extraction procedure. These include the rates at which the sample, wash, or eluent is aspirated/dispensed from the column, the composition of the sample solution, the wash solution, and the eluent, the gas used to purge liquid from the capillary following the wash step, the pressure at which the gas is applied, the duration for which the gas is applied, and the number of draw/expel cycles used for the sample loading, wash, and elution steps.

### Example 7

### Optimization of Proteins Identification from a Multi-Protein Complex

HeLa cell nuclear extract (5.0×10⁹ cells, Cat. No.CC-01-20-50) is obtained from CILBIOTECH (c/o Faculte Polytechnique de Mons, rue de l'Epargne 56, B-7000 MONS, Belgique). This extract is treated with Roche complete protease inhibitor tablets divided into 200-μl aliquots and stored at −80° C. 50 μl of the HeLa cell nuclear extract is routinely added to 550 μl PBS and passed through the capillary using protocol described in Example 6.

In this example, the multiprotein complexes of p54/PSF are analyzed. The extraction processes are carried out in a plurality of extraction capillaries and several factors are varied as described in Example 6. The p54 (or, non-Pou domain containing octamer binding protein) N-termini region possesses a natural His-tag sequence, whereby two adjacent histidines are separated from three adjacent histidines by a single glutamine residue—thus allowing for direct study of this multiprotein complex by open-tube capillary columns with Ni-IMAC surface.

HeLa nuclear extracts are prepared and the samples processed on the open-tube capillary columns. The complex is eluted from the columns, analyzed by SDS-PAGE and the yield and protein complement obtained from different capillaries is compared. Individual slices from the SDS-PAGE gels (as well as unfractionated “straight” eluate) are digested with trypsin, and the individual proteins associated with the complex are identified by LC-MS/MS. Proteins identified include PSF (polypyrimidine tract-binding protein associated splicing factor), DNA topoisomerase I and Paraspeckle I protein (PSP1).

### Example 8

### Method for Optimizing Desalting or Buffer Exchange Using a Gel Filtration Pipette Column

Gel filtration pipette-tip columns (such as the PHYTIP® 5K Desalting Columns sold by PhyNexus, Inc., San Jose, Calif.) can be used to de-salt a purified protein or perform buffer exchange. To optimize desalting or buffer exchange, the following factors are varied in automated experiments. First, gel filtration pipette-tip columns are conditioned with either water or buffer prior to addition of sample. The remaining interstitial fluid presents a variable for separation of the protein of interest from the unwanted salts or buffer. The effects of pushing different fluid volumes out of the pipette-tip column as well as the rate of push is examined.

Second, the range of optimal sample volume to add to the pipette-tip column will vary for the different resin bed sizes. Protein recovery is quantified to determine the appropriate pipette column for a specific sample size.

Third, sample protein concentration is a consideration for the effectiveness of pipette-tip columns in recovery of protein, as well. Finding the range of protein concentrations for optimal pipette column performance is necessary.

Fourth, elution of protein from the pipette column is a critical step. The rate at which the sample is expelled, the volume of additional air to push the sample through the pipette column and the delay time after the push are important for both the recovery of protein and retention/exchange of salts and buffer. In addition, a chaser can be used to maximize protein recovery while effectively desalting/exchanging buffer. As with the elution, the amount of chaser used to elute protein from the pipette column needs to be determined. Again, the rate of push, the volume of air to push and the delay time after the push also determine the effectiveness of the pipette columns.

While the invention has been described in connection with specific embodiments thereof, it will be understood that it is capable of further modifications and this application is intended to cover and variations, uses, or adaptations of the invention that follow, in general, the principles of the invention, including such departures from the present disclosure as come within known or customary practice within the art to which the invention pertains and as may be applied to the essential features hereinbefore set forth. Moreover, the fact that certain aspects of the invention are pointed out as preferred embodiments is not intended to in any way limit the invention to such preferred embodiments.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of optimizing a process for extracting an analyte from a liquid sample, wherein the process is characterized by a plurality of factors that can be independently varied and which affect the efficiency of the extraction, comprising the steps of:
(a) performing a plurality of the extraction processes in parallel, wherein at least two of the plurality of factors are independently varied across the plurality of extraction processes, each extraction process comprising the steps of:
(1) drawing up an analyte-containing sample solution into an extraction device having a single entrance for the input and output of liquids, wherein a different extraction device is used for each extraction process;
(2) expelling the sample solution from the extraction device;
(3) drawing an aliquot of elution liquid into the extraction device; and
(4) expelling and collecting the elution liquid; and
(b) assessing the efficiency of each of the plurality of extraction processes in extracting the analyte.

2. The method of claim 1, wherein at least two factors in the purification procedure are varied independently in a factorial or fractional factorial design.

3. The method of claim 2, wherein Design of Experiment is used to design a fractional factorial design.

4. The method of claim 2, wherein the process comprises one or more wash steps.

5. The method of claim 2, wherein the extraction device is a pipette tip-based extraction column.

6. The method of claim 2, wherein the extraction device is an extraction capillary.

7. The method of claim 2, wherein the at least two factors are selected from the group consisting of variation in the analyte, variation in the extraction chemistry, variation in the composition of any solution being passed through the extraction device, variation in the flow rate of a solution through the extraction devices, variation in the number of passages of a solution through the extraction devices, variation in the volume of any solution passed through the extraction devices, variation in the temperature of a solution passed through the extraction device, and variation in the temperature of the extraction device.

8. The method of claim 2, wherein the method is automated.

9. The method of claim 1, wherein the analyte-containing sample and elution liquids are provided in wells of a microplate.

10. The method of claim 1, wherein the analyte is a biomolecule.

11. The method of claim 11, wherein the biomolecule is a protein or protein complex.

12. The method of claim 1, wherein at least one of the factors assumes at least three different values in the method.

13. The method of claim 1, wherein at least three factors are varied.

14. The method of claim 1, wherein the variation of at least two are factors are partially correlated.
